(19) United States
(12) Patent Application Publication
(10) Pub. No.: US 2023/0196225 A1
(43) Pub. Date: Jun. 22, 2023

(54) RESOURCE ALLOCATION MANAGEMENT

(71) Applicant: Nabors Drilling Technologies USA, Inc., Houston, TX (US)

(72) Inventor: Blakley P. FARROW, Conroe, TX (US)

(21) Appl. No.: 18/058,070

(22) Filed: Nov. 22, 2022

Related U.S. Application Data
(60) Provisional application No. 63/265,546, filed on Dec. 16, 2021.

(51) Int. Cl. G06Q 10/0631; G06Q 10/0635; G06Q 50/08

(52) U.S. Cl. CPC G06Q 10/063112; G06Q 10/0635; G06Q 50/08

(57) ABSTRACT

A method for performing a subterranean operation, where the method can include operations of generating a database of a plurality of individuals, that can include an individual proficiency score for each of the individuals for each one of available rig tasks on a rig, where each one of the available rig tasks requires at least one of the individuals. Receiving a digital rig plan with a sequence of rig tasks to be performed on the rig, where the sequence of rig tasks comprises a subset of available rig tasks and allocating one or more of the individuals to each of the rig tasks in the sequence of rig tasks based on respective individual proficiency scores.

### CROSS-REFERENCE TO RELATED APPLICATION(S)

This application claims priority under 35 U.S.C. § 119(e) to U.S. Provisional Application No. 63/265,546, entitled “RESOURCE ALLOCATION MANAGEMENT,” by Blakley P. FARROW, filed Dec. 16, 2021, which is assigned to the current assignee hereof and incorporated herein by reference in its entirety.

### TECHNICAL FIELD

The present invention relates, in general, to the field of drilling and processing of wells. More particularly, present embodiments relate to a system and method for managing allocations of resources (such as rig equipment and individuals) to perform activities on a rig according to a well plan or a rig plan.

### BACKGROUND

During well construction operations, activities on a rig can be organized according to a well plan. The well plan can be converted to a rig plan (i.e., rig specific well construction plan) for implementation on a specific rig with specific recourses. Deviations from the well plan or rig plan can cause rig delays, increase well site operation execution times, and cause other impacts to operations. Poorly performed well plan activities or rig plan tasks at the rig site cause delays or possibly unplanned activities. Deviation from the plan can create safety issues for the crew and can also increase the risk of rig equipment damage. Therefore, improvements in rig resource management are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by the data processing apparatus, cause the apparatus to perform the actions. One general aspect includes a method for performing a subterranean operation. The method also includes generating, via a rig controller, a database of a plurality of individuals, the database may include an individual proficiency score for each of the individuals for each one of available rig tasks on a rig, where each one of the available rig tasks requires at least one of the individuals; receiving a digital rig plan which may include a sequence of rig tasks to be performed on the rig, where the sequence of rig tasks may include a subset of the available rig tasks; and allocating one or more of the individuals to each of the rig tasks in the sequence of rig tasks based on respective individual proficiency scores. Other embodiments of this aspect include corresponding computer systems, apparatus, and computer programs recorded on one or more computer storage devices, each configured to perform the actions of the methods.

Implementations may include one or more of the following features. The method may include: calculating, via the rig controller, a task risk score for each rig task in the sequence of rig tasks based on the respective individual proficiency score for each of the one or more individuals allocated to each of the respective rig tasks; and calculating, via the rig controller, a rig plan risk score based on the task risk scores; and storing the task risk scores and the rig plan risk score in the database. The method may include: calculating, via the rig controller, an individual risk score for each one of the one or more individuals allocated to a particular rig task of the sequence of rig tasks. The new sequence of rig tasks may include a subset of the available rig tasks; inserting the new sequence of rig tasks into the digital rig plan; and allocating one or more of the individuals to the rig tasks in the new sequence of rig tasks based on the respective individual proficiency scores.

The individual proficiency score indicates a competency of the individual to perform a particular one of the rig tasks. Two or more of the individual proficiency scores can be combined into a group proficiency score which indicates a competency of a group of individuals to perform a particular one of the rig tasks. The individual proficiency score for an individual performing a particular rig task of the available rig tasks is calculated based on at least one of: a level of performance of the individual when the individual previously performed the particular rig task; a level of compliance of the individual with required training for the particular rig task; whether the individual is a short service employee (SSE); an SSE level at which the individual is rated; a level of experience the individual has with performing the particular rig task; a level of experience the individual has with performing a similar task; a level of experience the individual has working on the rig; a level of experience the individual has working on a similar type of rig; environmental conditions present when the individual previously performed the particular rig task; hours worked before previously performing the particular rig task; hours rested before previously performing the particular rig task; vital signs of the individual before, during, and after previously performing the particular rig task; or combinations thereof.

Each one of the available rig tasks requires at least one of the plurality of rig equipment; and allocating one or more of the plurality of rig equipment to the rig tasks in the sequence of rig tasks based on respective rig equipment proficiency scores. Each of the individual risk scores is based on a respective individual proficiency score for the particular rig task; calculating for each particular rig task, via the rig controller, an equipment risk score for rig equipment allocated to the particular rig task, where each of the equipment risk scores is based on a respective rig equipment proficiency score for the particular rig task; and calculating, via the rig controller, a task risk score for each rig task in the sequence of rig tasks based on the respective individual risk scores and the respective equipment risk scores for the respective rig tasks. Implementations of the described techniques may include hardware, a method or process, or computer software on a computer-accessible medium.

One general aspect includes a method for performing a subterranean operation. The method also includes receiving, at a rig controller, a digital rig plan which may include a sequence of rig tasks to be performed on a rig, where the sequence of rig tasks may include a subset of available rig tasks; allocating one or more individuals to at least one of the rig tasks in the sequence of rig tasks based on a proficiency score for each individual for each of the rig tasks in the sequence of rig tasks; conducting the digital rig plan via the rig; receiving, at the rig controller, a deviation from the digital rig plan; determining a new sequence of rig tasks to perform the deviation from the digital rig plan, where the new sequence of rig tasks may include a subset of the available rig tasks; inserting the new sequence of rig tasks into the digital rig plan; and allocating one or more of the individuals to at least one of the rig tasks in the new sequence of rig tasks based on the proficiency score for each individual for each of the rig tasks in the new sequence of rig tasks. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of a user using possible wearable devices for user input or identification, in accordance with certain embodiments;

FIG. 2 is a representative partial cross-sectional view of a rig being utilized for a subterranean operation, in accordance with certain embodiments;

FIG. 3A is a representative front view of various users being detectable via an imaging system, in accordance with certain embodiments;

FIG. 3B is a representative flow diagram of a method for determining risk scores for individuals, rig equipment, and an overall rig plan, in accordance with certain embodiments;

FIG. 4 is a representative flow diagram of a method for allocating individuals or rig equipment to rig plan tasks based on a respective performance index, in accordance with certain embodiments;

FIG. 5 is a representative block diagram of an environment with multiple zones at a rig site, in accordance with certain embodiments;

FIG. 6 is a representative functional block diagram of a method using a computer to determine risk scores for various individuals, rig equipment, tasks, or overall rig plan, in accordance with certain embodiments;

FIG. 7A is a representative list of well activities for an example digital well plan, in accordance with certain embodiments;

FIG. 7B is a representative functional diagram that illustrates conversion of well plan activities to rig plan tasks, in accordance with certain embodiments; and

FIG. 8 is a representative functional diagram of a computing system (such as a rig controller) that illustrates rig controller functions and possible databases that can be used to convert a digital well plan to a digital rig plan, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

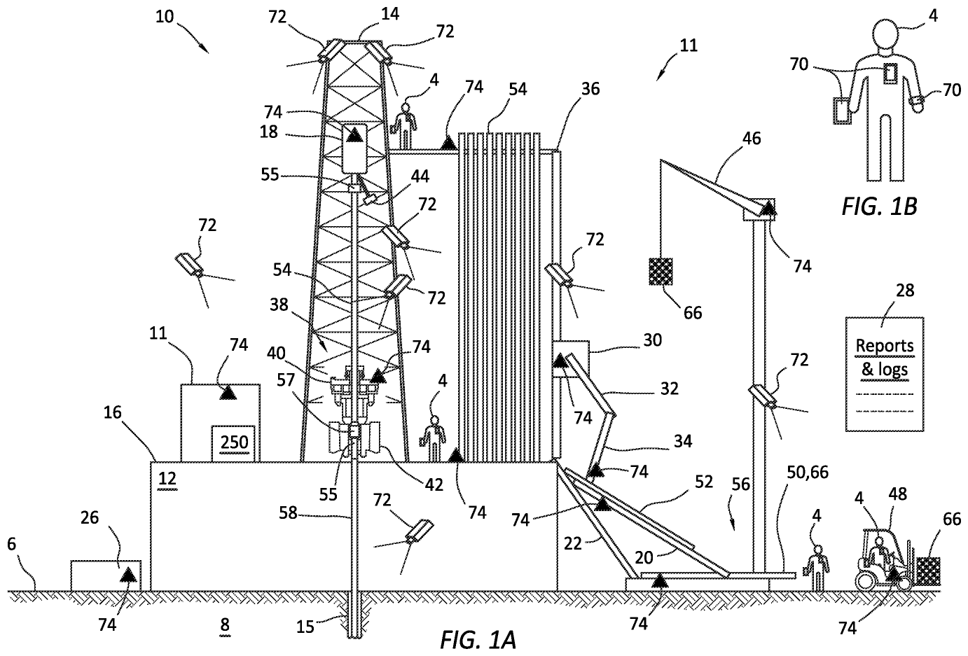

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the vertical storage area 36, the wellbore 15, etc. However, it is not required that a pipe handler 30 be used on the rig 10. The top drive 18 can transfer tubulars directly to and directly from the catwalk 20 (e.g., using an elevator coupled to the top drive). Also, a catwalk 20 is not required, since one or more pipe handlers 30 can be used to transfer tubulars between storage locations (horizontal or vertical) and a well center.

The tubular string 58 can extend into the wellbore 15, with the wellbore 15 extending through the surface 6 into the subterranean formation 8. When tripping the tubular string 58 into the wellbore 15, tubulars 54 can be sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 can be sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the vertical storage area 36, other storage locations, etc. The iron roughneck 38 can break a threaded connection between a tubular 54 being removed and the tubular string 58. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig, many other rig tasks are also needed to perform a well construction according to a digital well plan. For example, pumping mud at desired rates, maintaining downhole pressures (as in managed pressure drilling), maintaining, and controlling rig power systems, coordinating and managing personnel on the rig during operations, performing pressure tests on sections of the wellbore 15, cementing a casing string in the wellbore, performing well logging operations, as well as many other rig tasks. As used herein, “personnel”, “individual”, “user”, or “operator” can be used interchangeably in that each refers to a human that is available to support a subterranean operation.

A rig controller 250 can be used to control the rig 10 operations including controlling various rig equipment, such as the pipe handler 30, the top drive 18, the iron roughneck 38, the vertical storage area equipment, imaging systems, various other robots on the rig 10 (e.g., a drill floor robot), rig power systems 26, or instructing individuals on the rig. The rig controller 250 can control the rig equipment autonomously (e.g., without periodic operator interaction), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

A proficiency score for the rig equipment or an individual 4 can indicate how well the equipment or individual 4 has performed the task in the past, whether the individual may need further training or rest, or whether the equipment may need maintenance or repair. As used herein, “satisfactorily perform”, “satisfactorily performs”, or “performed satisfactorily”, refers to a performance of a task or activity that is within the performance guidelines or budgets provided in the digital well plan 100 or the digital rig plan 102.

Therefore, as used herein, a “proficiency score” refers to an indication as to an established ability or competency of an individual, a piece of rig equipment, or a rig 10 (including personnel) to satisfactorily perform a task of a digital rig plan 102 on the rig 10 or at the rig site 11 based on prior performances or training. The proficiency score can be updated in real-time as data sources provide real-time data to the rig controller 250 associated with the real-time performance of the individual, rig equipment, or rig 10 to the digital well plan 100 or digital rig plan 102. This real-time portion of the proficiency score can continue to be updated as the task is performed. Once the task is completed, the final real-time portion of the proficiency score for the individual or rig equipment can be stored in a database or other storage means (e.g., entry in a log or report) as historical proficiency data and can be used to determine a proficiency score for the individual or piece of rig equipment, where the proficiency score can be used for future risk score calculations.

A proficiency score for an individual or a piece of rig equipment can be determined for any and all possible tasks of a digital rig plan 102 for one or more types of rigs 10 and stored in the database or other storage means. A risk score, which can be determined based on the proficiency score, can be used to adapt future digital well plans 100, which can be modified to accommodate or take advantage of the proficiency scores of the individuals, the rig equipment, or the rig 10 (or rig site 11).

A proficiency score can be determined (e.g., by the controller 250) for an individual or a piece of rig equipment to be used in performing a task of a rig plan 102 for a subterranean operation. The proficiency score for the individual 4 can indicate if the individual 4 has performed the task satisfactorily in the past (e.g., performed the task on time, in the right location, with the correct resources, etc.). Depending on the proficiency score of the individual, it can also indicate compliance of the individual to the required training for a particular task or a need for additional skills training for the individual 4. The proficiency score for an individual 4 can indicate whether the individual 4 is a short service employee (SSE) and at what SSE level the individual is rated.

The proficiency score for an individual can indicate how much experience the individual has with performing the task or how much experience the individual has working on the designated rig type. The proficiency score can take into account the environmental conditions that were present when the previous tasks were performed, hours worked and hours rested before performing the previous tasks, vital signs before, during, and after performing the previous tasks, as well as other parameters that may affect the performance of a particular task by an individual 4.

A proficiency score for an individual or rig equipment can be determined for any and all possible tasks of a digital rig plan 102 and stored in a database. The proficiency scores in the database can be updated as new individuals are added to the workforce, abilities of current individuals change, abilities of current rig equipment change, additional equipment is provided, etc. The proficiency scores can be retrieved from the database to support the allocation of resources to tasks in a digital rig plan 102 that is created from a digital well plan 100 to determine the best fit for individuals and rig equipment for each task in the digital rig plan 102. When the individuals 4 and rig equipment are assigned to each task of the digital rig plan 102, the rig controller 250 can determine risk scores, based at least in part on respective proficiency scores, for each task and an overall risk score for the digital rig plan 102. Depending upon the risk scores, a rig manager, or the rig controller 250 can adjust the digital rig plan 102 to include more tasks, reallocate individuals based on at least a proficiency score, reallocate rig equipment based on at least a proficiency score, remove tasks, or otherwise modify the digital rig plan 102 to improve the overall risk score for the digital rig plan 102.

Where the proficiency score can indicate how a task is performed and how at least a portion of the current task has been performed, a risk score can indicate a probability that the task will be performed satisfactorily in the future or a probability that a current task being performed will be completed satisfactorily according to a digital rig plan 102 or digital well plan 100. As used herein, a “risk score” refers to a probability that the individual or the rig equipment can satisfactorily perform or complete an assigned task of a digital rig plan 102.

A risk score can be determined (e.g., by the rig controller 250) for individual(s) 4 or rig equipment used in performing a task of a digital rig plan 102 for a subterranean operation. The risk score for the individual 4 can indicate the probability that the individual 4 can perform the task satisfactorily (e.g., perform the task on time, in the right location, with the correct resources, etc.). The risk scores for the rig equipment can indicate that the equipment is healthy and able to satisfactorily perform the task(s), or that the equipment may need maintenance or repair before being used to perform the task(s). The risk scores for the individual(s) and the rig equipment can be evaluated by the rig controller 250 to determine the overall risk score for a task. Depending on the risk score, it can indicate if modifications to the digital rig plan 102 are needed to mitigate a risk of performance by either the individual or the rig equipment. The risk scores can indicate for example if additional individuals 4 or rig equipment are needed, if other individuals 4 or rig equipment are needed, if training of the individual 4 is needed, or if maintenance of the rig equipment is needed to execute the tasks.

A risk score can include an initial risk score component and a real-time risk score component. The initial risk score component can be determined from historical risk data associated with the individual or the rig equipment, where the historical risk data can be stored in a database readable by the rig controller 250 or otherwise provided to the rig controller 250. The historical risk data can include how many times and how well the individual or rig equipment completed a previously assigned task. The historical risk data can also take into account environmental conditions for the work area where previous tasks were performed.

The historical risk data can take into account an individual's historical vital signs, historical trends of vital signs, historical fatigue (e.g., hours worked, hours rested, injuries, illnesses, etc.) when performing the previous tasks. The historical risk data can include historical fatigue of the rig equipment (e.g., hours ran, hours out of service, previous equipment failure or damage, etc.). The historical risk data can be analyzed by simulation or machine learning to determine trends, such as if the performance of a piece of rig equipment or an individual is progressively decreasing or increasing or staying generally constant. Adjustments to the digital rig plan 102 can be made to take advantage of or accommodate these trends.

The real-time risk score component can be determined by receiving real-time risk data from various data sources (e.g., sensors) on the individual, on the rig equipment, or remotely positioned from either the individual or rig equipment. The data sources can provide data associated with the performance of an assigned task, and the rig controller 250 can analyze the data to determine a performance level of the individual or rig equipment and combine it with the initial risk score component to produce a real-time risk score of the task being performed. Again, the risk score is an indication of the probability that the individual or rig equipment will satisfactorily complete current or future tasks. This real-time risk score can continue to be updated as the task is performed. Once the task is completed, the final real-time risk score for the individual or rig equipment can be stored in a database or other storage means (e.g., entry in a log or report) as historical risk data, which can be used for future risk score calculations.

The real-time risk data can take into account a current or projected fatigue of an individual (e.g., how long the individual has been working since the last rest break, how many hours the individual has worked during the current week, how many hours of rest has the individual taken, how many hours required by the task, current injuries, current illnesses, etc.), instantaneous vital signs of the individual, trending vital signs of the individual, current or projected fatigue of a piece of rig equipment (e.g., the current performance of the piece of rig equipment, projected maintenance service schedule, etc.), or the current or forecasted environmental conditions (e.g., weather conditions, such as snow, rain, sleet, wind, sea conditions (such as for off-shore rigs), temperature, etc.) for a designated work area that can affect the ability of the individual or rig equipment to perform the particular task.

The rig controller 250 can include one or more processors with one or more of the processors distributed about the rig 10 (or rig site 11), such as in an operator's control hut 13, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure using data stored in various databases. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., sensors 72, 74, electronic devices like wearables 70, user input, local rig reports, etc.) and from remote data sources (e.g., suppliers, manufacturers, transporters, company men, remote rig reports, etc.) to monitor and facilitate the execution of a digital well plan 100. A digital well plan 100 is generally designed to be independent of a specific rig, whereas a digital rig plan 102 is a digital well plan 100 that has been modified to incorporate the specific equipment available on a specific rig and best practices to execute the well plan 100 on the specific rig, such as rig 10. Therefore, the rig controller 250 can be configured to monitor and facilitate the execution of the digital well plan by monitoring and executing rig tasks in the digital rig plan.

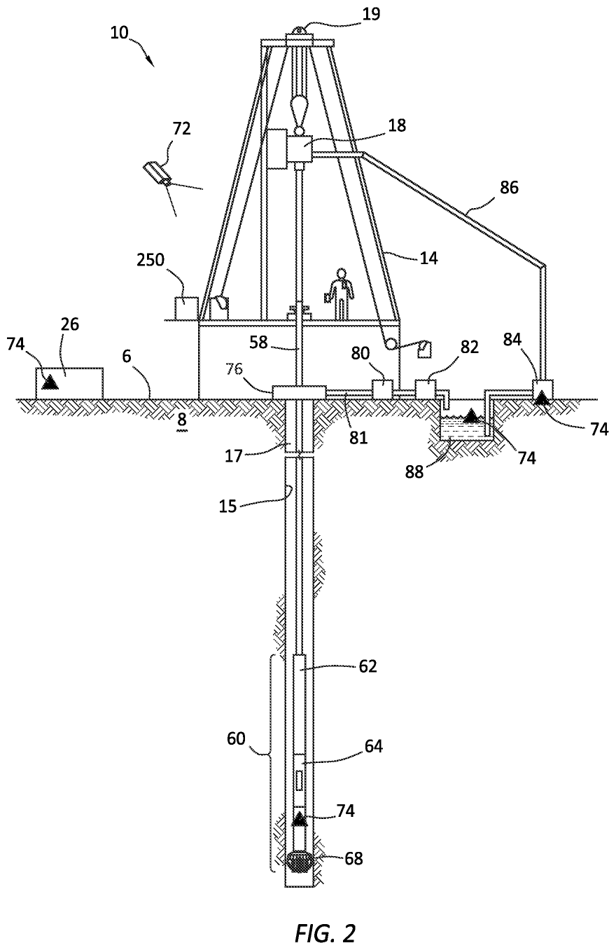

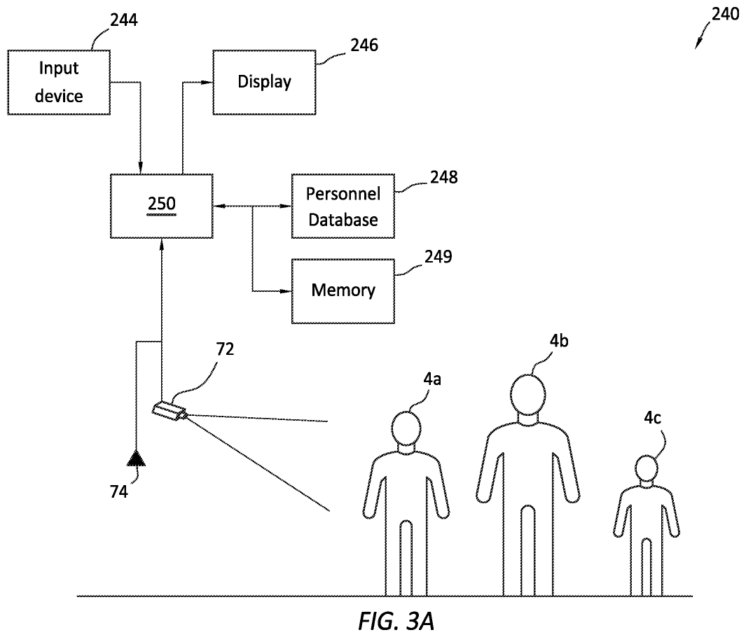

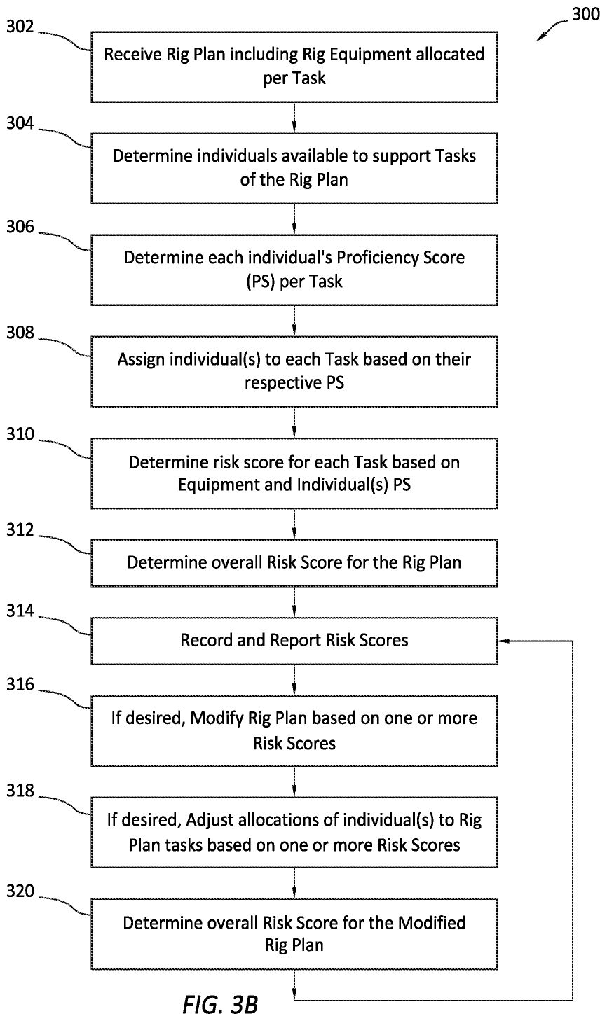

Examples of local data sources are shown in FIG. 1A where an imaging system (e.g., imaging system 240 in FIG. 3A) can include the rig controller 250 and imaging sensors 72 positioned at desired locations around the rig and around support equipment/material areas, such as mud pumps (see FIG. 2), the horizontal storage area 56, power system 26, etc., to collect imagery of the desired locations. Also, various sensors 74 can be positioned at various locations around the rig site 11 and the support equipment/material areas to collect information from the rig equipment (e.g., pipe handler 30, roughneck 38, top drive 18, vertical storage 36, etc.) and support equipment (e.g., crane 46, forklift 48, the horizontal storage area 56, power system 26, shaker 80, return line 81, fluid treatment 82, pumps 84, stand line 86, mud pit 88, etc.) to collect operational parameters of the equipment. As used herein, “rig equipment” refers to equipment used at the rig site 11, either on or off the rig 10, which includes the support equipment described above. Additional information can be collected (via the rig controller 250 or via an individual) from other data sources, such as reports and logs 28 (e.g., tour reports, daily progress reports, reports from remote locations, shipment logs, delivery logs, personnel logs, etc.).

These data sources can be aggregated by the rig controller 250 and used to determine an estimated well activity of the rig and comparing it to the digital well plan 100 to determine the progress and performance of the rig 10 in executing the digital well plan 100.

The data from the data sources can be received by the rig controller 250 and used to determine one or more tasks that are being performed at the rig site 11 by one or more individuals 4 or one or more pieces of rig equipment or combinations thereof in support of a well activity of the digital well plan 100. The rig controller 250 can use the data from the data sources to determine if the one or more tasks being performed in support of the well activity are either primary tasks or secondary tasks. As used herein, a “primary task” is a task performed by rig equipment or an individual, where the task is executing a well activity of the digital well plan. As used herein, a “secondary task” is a task performed by rig equipment or an individual, where the task is supporting the execution of the well activity of the digital well plan but is not directly executing the well activity. The secondary tasks can be performed simultaneously with the primary tasks but can also be performed at times other than simultaneously with the primary tasks, such as prior to the primary task to which it supports.

The rig controller 250 can calculate a risk score for the individual 4 or rig equipment performing the primary task or secondary task based on data from the data sources or based on historical data from past performances of the individual 4 or rig equipment performing the task. The risk score can indicate an ability of the individual 4 or rig equipment to perform the specific task (primary or secondary).

The risk score for a task can take into account whether the task is a primary task or a secondary task. In general, the secondary tasks can have a comparably lower risk score while the primary tasks can have a comparably higher risk score. Therefore, an individual performing the same task as a secondary task will generally have a lower risk score when compared to the same individual performing the same task as a primary task. Therefore, whether a task is a primary or secondary task can be combined with the other risk factors to determine the task risk score as well as the overall risk score for the digital rig plan 102. Additionally, if the execution of a secondary task causes delays in executing a primary task, then the secondary task can be changed to a primary task and the corresponding risk score for the task can be adjusted to take into account the elevated risk factor for completion of the task.

The risk score can include a real-time individual risk score component that can be based at least in part upon comparing an expected characteristic of the individual to an actual characteristic of the individual. The expected or actual characteristics of the individual can include a position of the individual within the environment, movement of the individual within the environment, movement of one or more body parts of the individual within the environment, health signal(s) of the individual from sensors monitoring the individual 4 or the environment, conditions within the environment, or combinations thereof. The expected characteristics can be measured in real-time based upon data received from the data sources.

For example, the imaging system (e.g., imaging system 240 in FIG. 3A) can detect a position of the individual 4 within the environment being monitored and the rig controller 250 can compare the position to an expected position, where the expected position can be stored in a database for retrieval as needed by the rig controller 250.

For example, the imaging system can detect movement of the individual 4 within the environment, and the rig controller 250 can compare the movement to an expected movement of the individual 4, where the expected movement can be stored in a database for retrieval as needed by the rig controller 250.

For example, the imaging system can detect movement of one or more body parts of the individual 4 within the environment and the rig controller 250 can compare the movement of the one or more body parts to an expected movement of the one or more body parts of the individual 4, where the expected movement of the one or more body parts of the individual 4 can be stored in a database for retrieval as needed by the rig controller 250.

For example, the imaging system can receive one or more health signals from sensors monitoring the individual 4 within the environment, and the rig controller 250 can compare the health signals to expected health signals of the individual 4, where the expected health signals can be stored in a database for retrieval as needed by the rig controller 250. The health signals can include vital signs for the individual 4, such as heart rate, blood pressure, oxygen level, calories burned, steps taken for a specific time period, breathing rate, etc.

For example, the imaging system can receive one or more health signals from sensors monitoring the environment, and the rig controller 250 can compare the health signals to expected health signals of the environment, where the expected health signals can be stored in a database for retrieval as needed by the rig controller 250.

For example, the imaging system can detect conditions within the environment and the rig controller 250 can compare the conditions to expected conditions within the environment, where the expected conditions can be stored in a database for retrieval as needed by the rig controller 250.

The risk score can be determined via the rig controller 250 by using artificial intelligence, such as a machine learning program, which can use historical risk data for the individual 4 or the piece of rig equipment to estimate the real-time risk score. The historical risk data can be input into an artificial intelligence engine of the rig controller 250 (e.g., a neural network for deep learning), which can learn the historical risk data for the individual 4 (or rig equipment) and use this learning to predict a risk score for an individual or rig equipment to perform an assigned task. The risk score can be sent to one or more individuals 4 via respective electronic devices (e.g., wearable electronics, portable electronics, etc.), stored in a database, or fed back into the artificial intelligence engine for further learning.

The data sources can include electronic devices such as the wearables 70 or sensors 72, 74. The wearables 70 (e.g., a smart wristwatch, a smart phone, a tablet, a laptop, an identification badge, a wearable transmitter, etc.) can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the electronic devices can be used for communication between the rig controller 250 and the electronic devices for information transfer. For example, the electronic device can send data associated with the individual 4, on which the electronic device is carried, to the rig controller 250. The rig controller 250 can use the individual's data to determine a risk score for the individual to perform the assigned task. The electronic devices (e.g., the sensors 72, 74, and wearables 70) can also send data associated with one or more pieces of rig equipment to the rig controller 250. The rig controller 250 can use the sensor data to determine a risk score for each piece of rig equipment.

The wearables 70 (i.e., electronic devices) can include a unique identification number that is associated with a respective individual 4. The unique identification number can be detectable by one or more active or passive detection systems in the environment. For example, an active detection system can be an imaging system 240 and a passive detection system can be an RFID reader that detects RFID devices in the environment. One or more of the wearables 70 can include processors that can be included in the rig controller 250, and these processors can be configured to calculate the risk score of the individual for performing the task. Sensors or other electronic devices can detect movements and actions of one or more individuals 4 in the environment or health signals of the individuals and calculate risk scores based on this information.

An electronic device (e.g., wearables 70) can include a display configured to display, to the individual, an alert, a change to the activity, a change to the task, a status of the activity, an individual risk score, a sensitivity value, an activity risk score, an individual proficiency score, an activity proficiency score, or any combination thereof.

FIG. 2 is a representative partial cross-sectional view of a rig 10 at a rig site 11 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 used to raise or lower the top drive 18. A derrick 14 extending from the rig floor 16, can provide the structural support of the rig equipment for performing subterranean operations (e.g., drilling, treating, completing, producing, testing, etc.). The rig 10 can be used to extend a wellbore 15 through the earthen formation 8 by using a tubular string 58 having a Bottom Hole Assembly (BHA) 60 at its lower end. The BHA 60 can include a drill bit 68 and multiple drill collars 62, with one or more of the drill collars including instrumentation 64 for LWD and MWD operations. During drilling operations, drilling mud can be pumped from the surface 6 into the tubular string 58 (e.g., via pumps 84 supplying mud to the top drive 18) to cool and lubricate the drill bit 68 and to transport cuttings to the surface via an annulus 17 between the tubular string 58 and the wellbore 15.

The returned mud can be directed from the rotating control device 76 (if used) to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue the circulation of the mud through the tubular string 58.

Sensors 74 and imaging sensors 72 can be distributed about the rig and downhole to provide information on the environments in these areas as well as operating conditions, the health of equipment or individuals 4, the well activity of equipment, positions of individuals 4 at the rig site 11, movements or actions of the individuals 4 at the rig site 11, fluid properties, WOB, ROP, RPM of the drill string, RPM of the drill bit 68, etc.

FIG. 3A is a representative front view of various individuals 4 (e.g., individuals 4a, 4b, 4c) that can be detectable via an imaging system 240. The imaging system 240 can include the rig controller 250, one or more imaging sensors 72, and one or more other sensors 74 (e.g., acoustic sensors, radio frequency identification RFID sensors, etc.), which can be positioned away from (or remote from) the individual 4. Some of the sensors or wearables 70 can be one or more electronic devices with wireless communication capabilities, which are worn or carried by the individual 4. When determining the current well activity or current task, it can be beneficial to detect how many individuals 4 are present on the rig 10, where they are, who they are, and what they are doing, as well as the rig equipment being used and the parameters of their use. For example, the imaging system 240 can be used to detect individuals 4 at the rig site 11, track their location as they move about the rig site 11, determine an identity of each of the individuals 4, determine the task each of the individuals is performing or is to perform, determine the time each individual should take to perform the task and compare it to the time each individual took to perform the task, score each individual 4 on a risk of satisfactorily performing the task of the digital rig plan, and score the individuals 4 on their proficiency of performing the task.

By receiving imagery from the one or more imaging sensors 72, or sensor data from other sensors 74 or other electronic devices 70, the rig controller 250 can analyze the sensor data to detect characteristics of the individuals (such as individuals 4a, 4b, 4c) captured by the imagery from the imaging sensor(s) or detected by the sensors 74 (e.g., acoustic sensors, RFID sensors, etc.). The rig controller 250 can compare the detected characteristics of each individual 4 (such as individuals 4a, 4b, 4c) with characteristics of individuals stored in the personnel database 248. The characteristics can include a detectable identification number (e.g., RFID device, bar code, QR code, etc.) physical characteristics, mannerisms, walking stride (or motion), body movements, silhouette, size, posture, body movements, facial features, or audible signals (e.g., via acoustic sensors 74). If the individual 4 is not included in the characteristics of individuals stored in the personnel database 248, the rig controller 250 can store the characteristics of the new individual in the personnel database 248 for future identification purposes.

The rig controller 250 can detect (or sense) an individual at the rig site 11 by using one or more sensors 72, 74, or electronic devices that are remotely positioned relative to the individual. The one or more sensors 72, 74 can communicate directly or indirectly to the rig controller 250, which can communicate to a wearable electronic device 70 disposed on the individual 4. The rig controller 250 can analyze information from the one or more sensors 72 74, the wearable electronic device 70, or electronic devices to confirm an identity of the individual 4. The information can include the detected characteristics of the individual 4. The individual 4 can also respond, via the wearable electronic device 70, to an inquiry from the rig controller 250 to the wearable electronic device 70 requesting confirmation of the individual's 4 identity. For example, a human machine interface provided by the wearable electronic device 70 such as a touch screen, can be used to receive input from the individual 4 to respond to the inquiry.

The rig controller 250 can detect (or sense) an individual in separate environments (e.g., red zone, drill floor, operator's control hut 13, vertical storage area 36, etc.) at the rig site 11 by using the one or more sensors 72, 74. The rig controller 250 can also determine a proficiency score for each of one or more individuals 4 that is associated with one or more of the environments on the rig 10. Some environments on the rig 10 can be referred to as “safe zones,” “red zones,” and “no-go zones.” As used herein, a “safe zone” is an environment or area on the rig 10 that is designated as being safe for individuals 4 during rig operations. As used herein, a “red zone” is an environment or area on the rig 10 that is designated hazardous to individuals 4 during rig operations, but the individuals 4 are allowed to enter the red zone to perform necessary tasks. As used herein, a “no-go zone” is an environment or area on the rig 10 that is designated unsafe for individuals 4 during rig operations and individuals 4 should be prevented from entering the no-go zones.

Based on the comparison of the detected characteristics to the stored characteristics, the rig controller 250 can determine the identity of each individual 4. The rig controller 250 can compare the tasks being performed by each identified individual 4 determine a length of time the individual took (or is taking) to perform the task, compare the task and the duration of the task with the digital well plan 100, and determine a proficiency score for the individual 4. One or more individual 4 proficiency scores and rig equipment proficiency scores can be used to calculate (via the rig controller 250) respective risk scores for the rig plan tasks.

Based on the comparison of the detected characteristics to the stored characteristics and respective proficiency scores, the rig controller 250 can determine a proficiency score for each individual 4 or rig equipment, and based on the proficiency scores, determine risk scores for each task to be performed by each individual 4 or rig equipment. One or more individual 4 risk scores and rig equipment risk scores can be used to calculate (via the rig controller 250) an overall activity risk score for performing the well activity of the digital well plan 100 (or digital rig plan 102).

The rig controller 250 can also determine a location at the rig site 11 of each individual 4 based on the identification of the surroundings around the individual 4 in captured imagery or based on other sensor data. The rig controller 250 can record, report, or display the individual's identity, location at the rig site 11, proficiency scores for each individual 4 and rig equipment, risk scores for each task of the rig plan 102 based at least in part on the proficiency scores for the individual 4 or rig equipment, risk scores for the rig equipment and individuals 4, and an overall risk score for the digital rig plan 102.

In a non-limiting embodiment, FIG. 3B is a representative flow diagram of a method 300 for using the rig controller 250 to determine an overall risk score for the digital rig plan 102. At operation 302, the rig controller 250 can receive a digital rig plan 102 that has been created from a digital well plan 100 (e.g., via the rig controller 250). The digital rig plan 102 can include a list of tasks to be performed on the rig 10 using the rig equipment of the rig 10 and the rig site 11. The rig plan 102 can include an initial allocation of one or more pieces of rig equipment per task to be used to perform that task at the rig site 11. The rig controller 250 can retrieve, such as from a database, a proficiency score for each piece of equipment for each task. At operation 304, the rig controller 250 can determine the number of individuals 4 that are available to perform each task of the rig plan 102. In operation 306, the rig controller 250 can determine a proficiency score for each one of the available individuals 4 by calculating the proficiency score or by retrieving the proficiency score from a database.

In operation 308, the rig controller 250 can allocate (or assign) one or more of the available individuals 4 to one or more of the rig plan tasks based on the proficiency scores for each individual for each task. In operation 310, rig controller 250 can then calculate a risk score for each task based on the proficiency scores for each individual 4 and piece of rig equipment allocated to the task. In a non-limiting embodiment, a non-exclusive list of risk factors used in determining each risk score is described above in reference to FIGS. 1A-2. In operation 312, the rig controller 250 can determine an overall risk score for the rig plan 102 based on the risk scores for each task.

In operation 314, the rig controller 250 can record the task and rig plan risk scores in a database for future retrieval and can report the risk scores to local and remote users. In operations 316 and 318, the rig controller 250 can review the tasks and rig plan risk scores to identify potential performance issues for executing the rig plan 102. If the risk scores identify one or more tasks, one or more individuals, or one or more pieces of rig equipment that appear to drive higher risks in the overall rig plan 102, then the rig controller 250 can autonomously or via inputs from a user 4 modify the rig plan 102 to mitigate these areas of higher risk. Modifications to the rig plan can include adding one or more tasks to the rig plan 102, reallocating individuals based on at least a proficiency score for each individual 4, reallocating rig equipment based on at least a proficiency score for each piece of rig equipment, remove tasks from the rig plan 102, or otherwise modify the rig plan 102 to improve the overall risk score for the rig plan 102. The rig controller 250 can also perform simulations of one or more tasks based on the allocated individuals 4 and allocated rig equipment for each task to identify ways to lower an overall risk score of the rig plan 102.

In operation 320, the rig controller 250 can calculate the overall risk score for the modified rig plan 102 based on the new allocations of equipment or individuals, and possibly a revised rig plan task list. If the overall risk score for the modified rig plan 102 is still above a desired risk score, then the method 300 can proceed back to operation 314 to record and report the resulting risk scores and proceed to repeat operations 316 thru 320 until the risk score is at an acceptable value, or below a predetermined value.

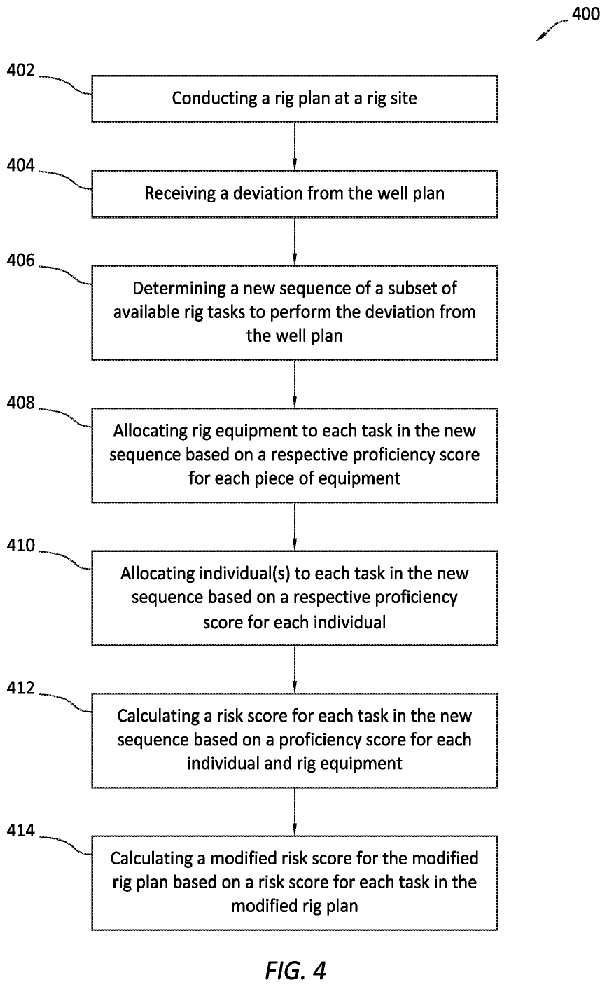

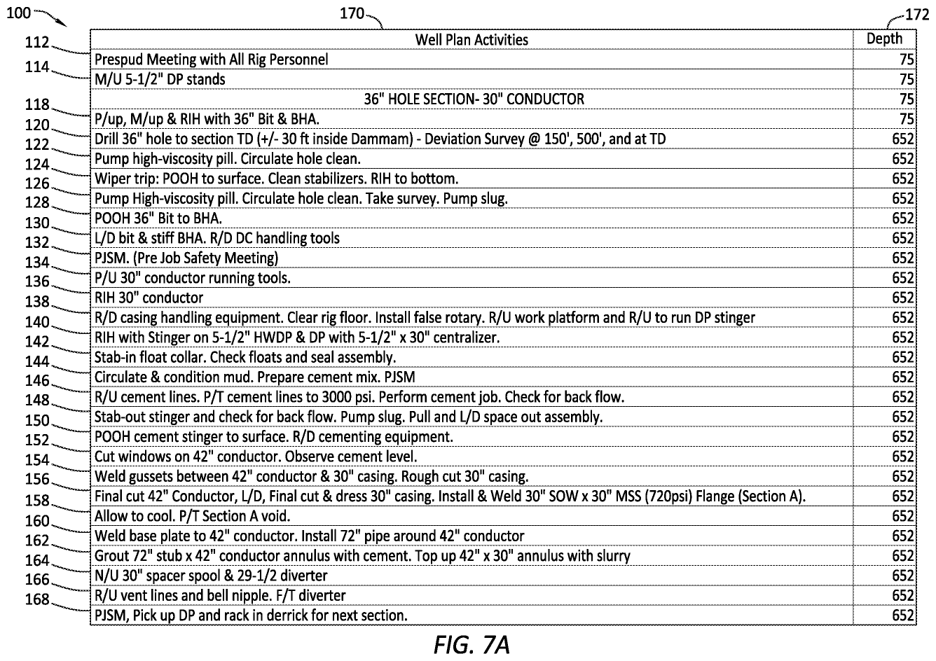

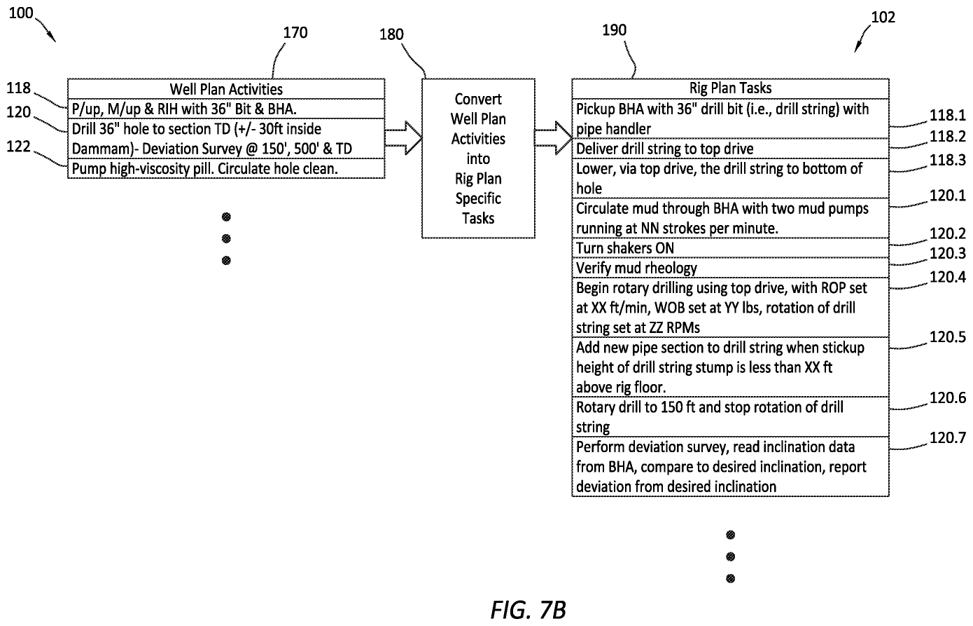

FIG. 4 is a representative flow diagram of a method 400 for calculating an overall risk score for a modified digital rig plan 102 after receiving a deviation from an original rig plan 102. Example rig plan tasks 190 are shown in FIG. 7B after being converted from the well plan activities 170 via the conversion engine 180 (refer to FIG. 7B). As the rig plan 102 is being executed, the deviation from the original well plan 100 or rig plan 102 can be detected or identified (e.g., an unplanned activity). The conversion engine 180 can convert the deviation from the well plan 100 (e.g., an unplanned activity or activities) into a corresponding new sequence of rig tasks 190 to handle the deviation on the rig 10. The new sequence of rig tasks 190 can be inserted as needed into the original list of rig tasks 190.

The method 400 can be used to allocate rig resources (e.g., individuals 4 or rig equipment) to the new sequence of rig tasks 190 to handle the deviation from the well plan 100 and calculate a new overall risk score for the modified rig plan 102. In a non-limiting embodiment, the method 400 can include operations 402 thru 414. Operation 402 can include conducting a rig plan 102 at a rig site 11, such as the rig tasks 190 shown in FIG. 7B.

In operation 404, the rig controller 250 can receive (or detect) a deviation from the original well plan 100 (or a deviation from the rig plan 102 that may not affect the well plan 100). In operation 406, the rig controller 250 can convert the deviation from the well plan 100 into a new sequence of rig tasks that can be a subset of the available rig tasks.

In operation 408, the rig controller 250 can allocate one or more pieces of rig equipment to each task of the new sequence of rig tasks based at least partially on the proficiency scores of the pieces of rig equipment for performing the particular tasks. In operation 410, the rig controller 250 can allocate zero, one, or more individuals 4 to each task of the new sequence of rig tasks based at least partially on the proficiency scores of the individuals 4 for performing the particular tasks.

In operation 412, the rig controller 250 can calculate a risk score for each task in the new sequence based on a proficiency score for each individual 4 and for each piece of rig equipment that has been allocated to each task. With the risk scores determined for each task in the new sequence of rig tasks, in operation 414, the rig controller 250 can recalculate the overall risk score for the modified rig plan to determine a modified risk score for the modified rig plan. If the modified rig plan is above a desired risk value, then the operations from the method 300 shown in FIG. 3B can be used to further modify the rig plan or modify the resource allocations to reduce the overall modified risk score to a value below the desired risk value.

As similarly stated above, the risk score can indicate the probability the individual or rig equipment can satisfactorily perform the task. High risk scores indicate a high likelihood that the individual or rig equipment will not successfully complete the task as planned in the rig plan 102. Low risk scores indicate a high likelihood that the individual or rig equipment will successfully complete the task as planned in the rig plan 102 or even better than planned (i.e., exceeds performance expectations compared to the planned performance guidelines or budgets in the rig plan 102). Based on one or more individual task risk scores, the rig controller 250 can determine an overall risk score for an activity of the well plan 100 (e.g., a subset of rig tasks for performing the well plan activity) which can indicate the probability that the activity will be satisfactorily performed.

If the risk scores are high, then the digital rig plan 102 can be adapted to allocate more time for execution of tasks, provide more individuals or rig equipment to perform a task, or adapt the digital rig plan 102 to perform the activity of the well plan using different tasks, different individuals, or different rig equipment. Conversely, if the risk scores are low, then the digital rig plan 102 can be adapted to allocate less time for the execution of tasks or provide fewer individuals or rig equipment to perform a task. The digital rig plan 102 can be adapted to assign individuals 4 or rig equipment to each task of the digital rig plan 102 based at least in part on the proficiency and risk scores of the individuals and rig equipment.

The risk scores for the rig equipment can be used to indicate that future maintenance activities may be needed, that the equipment is performing as good or better than expected, or that the equipment has failed and needs to be repaired or replaced. The proficiency scores of the individuals can be used to indicate if one or more of the individuals 4 need additional training, are masters of the tasks performed, are working with outdated tools, or other performance metrics. The proficiency scores can be monitored over time to determine a risk score for each individual 4 to perform the task, which can be used to indicate a probability of whether or not the individual 4 will perform the task adequately in the future.

Calculating the risk score can include weighting factors, such as an individual's proficiency score (which can include the individual's experience level, familiarity with the rig, familiarity with the rig equipment, familiarity with the rig procedure, familiarity with the activity, level of training completed, etc.), environmental conditions, actual or perceived injuries, hours active, hours rested, risk scores of other individuals working with the individual, proficiency score for the rig equipment (which can include the health of the equipment, scheduled maintenance events, etc.) or combinations thereof. Therefore, a high risk score can indicate a high probability that the individual 4 or rig equipment may take longer to perform the task(s) than expected, may harm the equipment or individual 4 when performing the task(s), or even fail to perform the task(s) in the future. A low risk score can indicate a high probability that the individual 4 or rig equipment may perform the task(s) quicker than expected, perform the task(s) with efficiency, perform the task within the guidelines or budgets given in the rig plan 102, or helping to improve the efficiency of others.

The risk score can be stored in a database for later retrieval by the rig controller 250 when calculating other risk scores. The risk scores for individuals in a group can be used to determine an overall risk score for the group (e.g., group of 3rd party contractors, group of individuals working 1st, 2nd, or 3rd shifts, group of new hires fresh out of training, etc.). The group risk score can be adjusted over time as the risk scores for each of the individuals 4 that make up the group are monitored and adjusted.

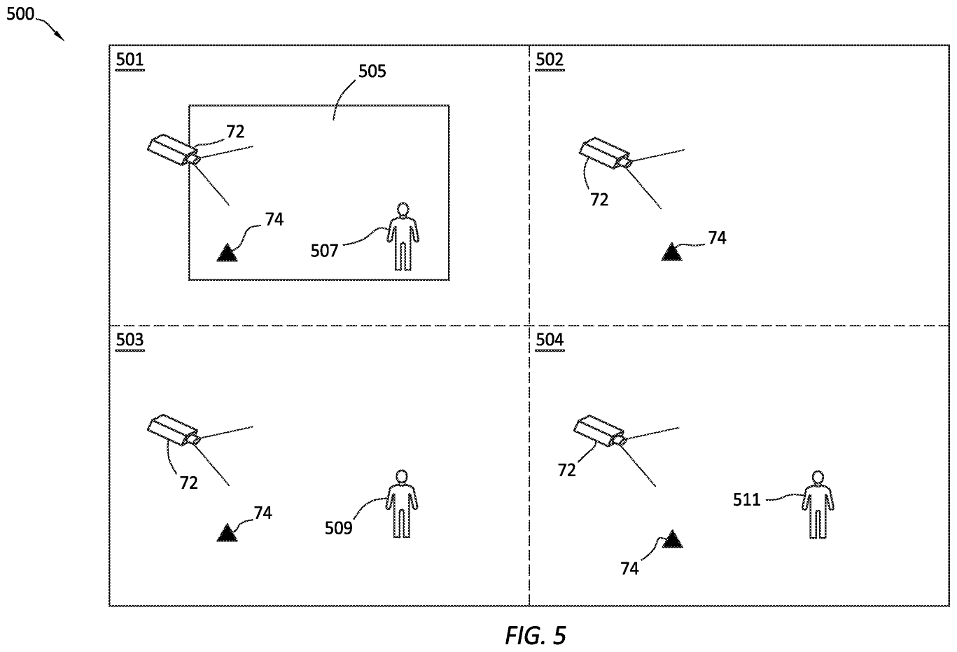

FIG. 5 is a representative block diagram of an environment 500 with multiple regions 501, 502, 503, 504 at a rig site 11. These regions can be different shapes as needed to organize access of individuals 4 to the regions 501, 502, 503, 504. Each region 501, 502, 503, 504 can include one or more imaging sensors 72 and one or more sensors 74. These sensors 72, 74 can capture sensor data (e.g., image data, acoustic data, proximity sensor data, thermal sensor data, vibration sensor data, RFID data, etc.) and communicate the sensor data to the rig controller 250, which can correlate the sensor data with the particular region 501, 502, 503, 504 from which the sensor data was collected. The regions 501, 502, 503, 504 can each be different than the other regions.

For example, region 501 can include a subregion 505. The subregion 505 (which can include the entire region 501), can be a red zone where drop hazards are possible and that individuals 4 (e.g., individual 507) should minimize their time within the red zone 505. This can be seen as the individual 507 entering the red zone 505, performing the needed task, and exiting the red zone 505 after completion of the task to minimize exposure of the individual 507 to the red zone 505. The sensors 72, 74, and the rig controller 250 can detect one or more individuals 4 in the subregion 505, determine the task(s) performed by the individuals 4 in the subregion 505, and log the task(s) which were performed as well as log the ability of the individual(s) to perform the task. This can be used to determine or modify a risk score or a proficiency score of the individuals 4 that performed the task(s).

Region 502 indicates that some of the regions 501, 502, 503, 504 may at times not have an individual 4 within them. The region 502 may, at some point in executing the digital well plan 100 (or digital rig plan 102) may have only rig equipment operating in it. The sensors 72, 74, and the rig controller 250 can be used to detect which of the rig equipment is being operated in the region 502 to perform a well activity.

Sensors 72, 74 in regions 503, 504 can detect individuals 4 in each of the regions as well as detecting the rig equipment operating in the regions 503, 504 to perform one or more well activities. The sensors 72, 74 in region 503 and the rig controller 250 can identify an individual 509 performing a task in support of a well activity with sensors 72, 74 in region 504 and the rig controller 250 that can identify an individual 511 (which can be different than the individual 509) performing another task in support of another well activity, or possibly in support of the same well activity that is being supported by region 503. The sensors 72, 74, along with the rig controller 250, can detect the individuals in each of the regions 501, 502, 503, 504 and determine the identity of each of the individuals 4 (e.g., 507, 509, 511), as well as determine the task that each individual 4 is performing. The rig controller 250 can also predict the task each individual 4 is to perform in any of the regions 501, 502, 503, 504 based on the digital rig plan 102.

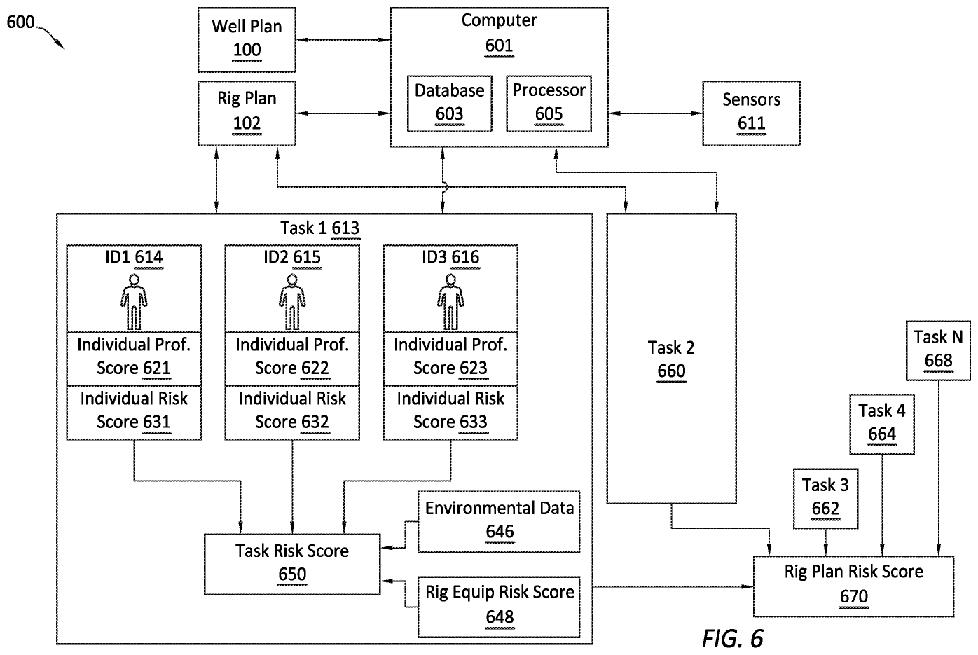

FIG. 6 is a functional block diagram of a method 600 using a computer 601 to determine risk scores 631, 632, 633, 648, 650 for various individuals, rig equipment, and tasks 613, 660, 662, 664, 668. The computer 601, as described in more detail below regarding FIGS. 7A, 7B, can receive a digital well plan 100 and convert the digital well plan 100, via processor(s) 605 and one or more databases 603, into a rig specific digital rig plan 102 for executing the digital well plan 100 on the rig 10. The computer 601 can receive sensor data from sensors 611 (e.g., sensors 72, 74). The rig 10 can begin executing one or more rig tasks, such as tasks 613, 660, 662, 664, 668 according to the digital rig plan 102. These can be serial tasks that are executed one after another, or they can be parallel tasks where at least a portion of a task (such as task 660) is performed simultaneously with at least a portion of the task 613.

Before the task 613 is executed, the computer 601 can establish a risk score that is equivalent to an initial risk score component for the individuals, rig equipment, and tasks 613, 660. The initial risk score component can be determined from historical risk data, calculated from current risk factors prior to execution of the tasks, or determined through simulation of the rig plan 102 based on the current rig environment and current risk factors. The initial risk score component can be used to determine if there is a good probability that the tasks will be performed according to the digital rig plan 102, or if modifications to the digital rig plan 102 may be needed to mitigate some or all of the risks indicated by the risk scores.

During the execution of at least one of the tasks 613, 660, 662, 664, 668 the computer 601 (e.g., the rig controller 250) can collect sensor data from the sensors 611 and use the sensor data to determine an estimated task for each individual or rig equipment based on the sensor data and then compare the sensor data to reference data stored in a database to verify that the estimated task is the actual task being performed. The reference data can include historical data collected from previously completed tasks. An actual task of the individual or rig equipment can include referencing a database with stored information related to the actual task of the individual or rig equipment, or sensing the actual task of the individual via one or more sensors monitoring the environment, or actively confirming the actual task of the individual with the individual via the electronic device; or combinations thereof. The identification of the actual task of the individual 4 can be confirmed by referencing a database having stored information related to the task of the individual or sensing the task of the individual via one or more sensors in the environment, or actively confirming the task of the individual with the individual via the electronic device.

During the execution of the tasks 613, 660, 662, 664, 668 the rig controller 250 can collect sensor data from the sensors 611 and use the sensor data to determine a real-time risk score component that can be used to modify the initial risk scores in real-time to determine a real-time risk score. The real-time risk score can indicate a real-time probability that the task will be completed satisfactorily or if rig plan modifications are necessary to mitigate the risks to ensure satisfactory completion of the digital well plan 100.

The computer 601 can use the sensor data from various data sources to identify each of the individuals 4 (e.g., individuals 614, 615, 616) that may be assigned to perform a task or may be performing a task. The computer 601 can also determine the task to be performed or the task being performed by each individual based on either the digital rig plan 102, sensor data, or both. The computer 601 (e.g., rig controller 250) can determine a respective proficiency score(s) 621, 622, 623 for one or more individuals (e.g., individuals 614, 615, 616) assigned to perform the task 613. The individual risk scores 631, 632, 633 can be determined by combining an initial individual risk score component with a real-time risk score component as described above, where the individual risk scores 631, 632, 633 are based at least partially on the respective proficiency score(s) 621, 622, 623.

The computer 601 can determine a respective risk score 648 for the rig equipment that may be used for performing tasks 613, 660, 662, 664, 668. The computer 601 can receive environmental data 646 from data sources that can detect environmental conditions in the work area of the tasks 613, 660, 662, 664, 668. The environmental data 646 can also include forecasted environmental conditions. The computer 601 can then calculate a task risk score 650 that can incorporate the individual risk scores 631, 632, 633 (depending on which individuals are used), the rig equipment risk score 648 (if used), and the environmental data 646. A task risk score 650 can be calculated for each task from task 1 (i.e., task 613) to task N (i.e., task 668), with the tasks 1 to N representing the list of tasks in the digital rig plan 102. The computer 601 can calculate an overall risk score 670 of the rig plan 102 based on the task risk score 650 for each task 613, 660, 662, 664, 668.

FIG. 7A is a representative list of well plan activities 170 for an example digital well plan 100. This list of well plan activities 170 can represent the activities needed to execute a full digital well plan 100. However, in FIG. 7A the list of activities 170 is merely representative of a subset of a complete list of activities needed to execute a full digital well plan 100 to drill and complete a wellbore 15 to a target depth (TD). The digital well plan 100 can include well plan activities 170 with corresponding wellbore depths 172. However, these activities 170 are not required for the digital well plan 100. More or fewer activities 170 can be included in the digital well plan 100 in keeping with the principles of this disclosure. Therefore, the following discussion relating to the well plan activities 170 is merely an example to illustrate the concepts of this disclosure. The well plan 100 can also define activities to be performed for other subterranean operations other than drilling, such as completion, treatment, production, abandonment, etc.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can for example require a pipe handler, horizontal or vertical storage areas for tubular segments, or tubular stands. The primary activities can be seen as the make-up of the drill pipe (DP) stands, with the secondary tasks being, for example, availability of tubular segments to build the DP stands; availability of a pipe handler (e.g., pipe handler 30) to manipulate the tubulars; a torquing wrench and backup tong for torquing joints when assembling the DP stands in a mousehole, a horizontal storage area, or a vertical storage area; available space in a storage area for the DP stands; doping compound and doping device available for cleaning and doping threads of the tubulars 50, and appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary tasks can be delivering the BHA components, including the drill bit, to the rig site; monitoring the health of the equipment to be used; and ensuring personnel are available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the drill bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary tasks can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the individual 4 can make sure that enough tubular stands 54 (or tubulars 50) are racked in the vertical storage 36 and accessible to the pipe handler 30 (or another pipe handler if needed). Additional secondary tasks can be seen as ensuring that the doping compound and doping device are available for cleaning and doping threads of the tubulars 50; mud additives are available for an individual 4 (e.g., mud engineer) or an automated process to condition the mud as needed; the top drive 18 (including drawworks), iron roughneck 38, slips, and pipe handlers are operational; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary tasks can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and individual 4 to clean the stabilizers; and operating the top drive 18, the iron roughneck 38, and slips to again connect tubulars 50 (or tubular stands 54) to the tubular string 58; and run the tubular string 58 back into the wellbore 15.

The secondary tasks can be seen as having the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can include the personnel, equipment, or materials 66 needed to directly execute the well plan activities using the specific rig 10. The secondary tasks can be those activities that ensure the personnel, equipment, or materials 66 are available and configured to support the primary activities.

FIG. 7B is a functional diagram that can illustrate the conversion of well plan activities 170 to rig plan tasks 190 of a rig specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct specific operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to one or more rig specific tasks 190 to create a digital rig plan 102 that can be used to direct tasks on a specific rig, such as rig 10, to construct the desired wellbore 15.

As a way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig specific activity 120 into, for example, seven rig-specific tasks 120.1 to 120.7. Task 120.1 can instruct the rig operators or rig controller 250 to circulate mud through the top drive 18, through the tubular string 58, through the BHA 60, and exiting the tubular string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15 and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling when the top end of the tubular string 58 is less than “XX” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “XX” ft above the rig floor 16.

At task 120.6, add tubular segments 50, 54 to the tubular string 58 as needed in task 120.5 to drill the wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that are to be used in the wellbore construction.

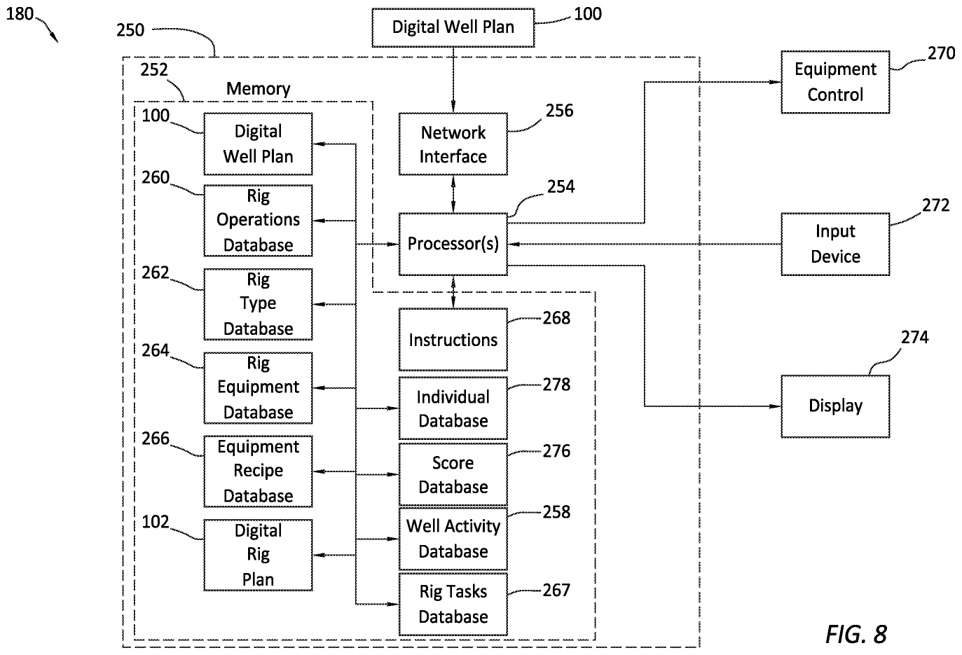

FIG. 8 is a representative functional block diagram of the rig plan conversion engine 180 that can include possible databases used by a rig controller 250 to convert a digital well plan 100 to a digital rig plan 102, for identifying individuals detected in work zones on the rig 10, storing and providing historical risk data (e.g., score database 276) and storing and providing historical proficiency data (e.g., score database 276). The rig plan conversion engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 8, the processor(s) 254 are communicatively coupled to the non-transitory memory 252 which can store multiple databases for converting the well plan 100 into the rig plan 102 and for identifying individuals detected in work zones on the rig 10. The databases identified in this disclosure may be described as being separate, but the databases can be combined in a single database or organized in multiple databases that combine some databases into one database with other databases combined into another database. For example, the individual database 278 can be combined with the score database 276. They are described as being separate for purposes of discussion.

A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operational tasks to rig specific tasks to implement the operations on the rig 10. The rig specific tasks can include the appropriate equipment for rig 10 to perform the operation task. The equipment selection for each rig specific task can also be determined, at least in part, based on a proficiency score for each rig equipment, where the proficiency scores can indicate the proficiency of the equipment to perform the particular task. The processor(s) 254 can retrieve proficiency scores for the rig equipment from the score database 276 and use the proficiency scores to better allocate rig equipment to the particular rig specific tasks.

The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.).

When the rig specific tasks of the rig plan 102 are defined and the rig equipment is allocated to each task of the rig plan 102, the processor(s) 254 can then allocate one or more individuals 4 to each of the rig plan 102 tasks. Similar to the allocation of the rig equipment, the processor(s) 254 can retrieve proficiency scores from the score database 276 for each of the individuals in the individual database 278 for performing the particular task and select the best individual(s) for performing the particular task. The processor(s) 254 can allocate the individuals at least partially based on the retrieved proficiency scores, but the processor(s) 254 can also adjust allocations to level the work to be done across the available workforce even when a proficiency score may possibly indicate other individual(s) to perform a particular task. If the proficiency scores for the individuals or rig equipment are adjusted during the execution of the rig plan 102, then the adjusted proficiency scores can be stored back in the score database 276 for future utilization.

The processor(s) 254 can calculate the individual risk scores based on historical risk data stored in the score database 276 and the overall risk score for the rig plan 102. If the risk scores indicate risk values above a desired value, then the resource allocations can be adjusted to mitigate the elevated risk values, or the rig plan 102 can be modified as described above to mitigate the performance risks. The calculated risk scores can be stored in the score database 276 for future utilization.

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during the execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

### VARIOUS EMBODIMENTS

Embodiment 1. A method for performing a subterranean operation, the method comprising:
generating, via a rig controller, a database of a plurality of individuals, the database comprising an individual proficiency score for each of the individuals for each one of available rig tasks on a rig, wherein each one of the available rig tasks requires at least one of the individuals;
receiving a digital rig plan which comprises a sequence of rig tasks to be performed on the rig, wherein the sequence of rig tasks comprises a subset of the available rig tasks; and
allocating one or more of the individuals to each of the rig tasks in the sequence of rig tasks based on respective individual proficiency scores.

Embodiment 2. The method of embodiment 1, further comprising:
calculating, via the rig controller, a task risk score for each rig task in the sequence of rig tasks based on the respective individual proficiency score for each of the one or more individuals allocated to each of the respective rig tasks; and
calculating, via the rig controller, a rig plan risk score based on the task risk scores; and
storing the task risk scores and the rig plan risk score in the database.

Embodiment 3. The method of embodiment 2, further comprising:
comparing the rig plan risk score to a desired rig plan risk score.

Embodiment 4. The method of embodiment 3, further comprising:
modifying the digital rig plan to reduce the rig plan risk score when the rig plan risk score is higher than the desired rig plan risk score.

Embodiment 5. The method of embodiment 4, wherein modifying the digital rig plan comprises at least one of:
adding one or more new rig tasks to the digital rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

Embodiment 6. The method of embodiment 5, further comprising:
calculating a modified rig plan risk score based on the modified digital rig plan;
comparing the modified rig plan risk score to a desired rig plan risk score; and
further modifying the digital rig plan to reduce the rig plan task score when the modified rig plan task score is higher than the desired rig plan risk score.

Embodiment 7. The method of embodiment 1, further comprising:
calculating, via the rig controller, an individual risk score for each one of the one or more individuals allocated to a particular rig task of the sequence of rig tasks.

Embodiment 8. The method of embodiment 7, wherein the individual risk score indicates a probability that the respective one of the one or more individuals will satisfactorily complete the particular rig task.

Embodiment 9. The method of embodiment 7, wherein the individual risk score for an individual performing a particular rig task of the available rig tasks is calculated based on at least one of:
the respective individual proficiency score;
current health of the individual;
current fatigue of the individual;
projected fatigue of the individual; and
environmental conditions in a work zone of the particular rig task; or combinations thereof.

Embodiment 10. The method of embodiment 9, wherein the individual risk score comprises a historical risk component and a real-time risk component, wherein the historical risk component is stored in the database and retrieved when the rig controller is allocating one or more of the individuals to one or more of the rig tasks.

Embodiment 11. The method of embodiment 10, wherein the real-time risk component is updated in real-time based on data received at the rig controller from data sources positioned on or off the rig.

Embodiment 12. The method of embodiment 1, further comprising:
receiving a deviation from the digital rig plan;
determining a new sequence of rig tasks to perform the deviation from the digital rig plan, wherein the new sequence of rig tasks comprises a subset of the available rig tasks;
inserting the new sequence of rig tasks into the digital rig plan; and
allocating one or more of the individuals to the rig tasks in the new sequence of rig tasks based on the respective individual proficiency scores.

Embodiment 13. The method of embodiment 12, further comprising:
calculating, via the rig controller, a task risk score for each rig task in the digital rig plan based on the respective individual proficiency score for each of the one or more individuals allocated to each of the respective rig tasks in the digital rig plan; and
calculating, via the rig controller, a rig plan risk score based on the task risk scores; and
storing the task risk scores and the rig plan risk score in the database.

Embodiment 14. The method of embodiment 13, further comprising:
comparing the rig plan risk score to a desired rig plan risk score.

Embodiment 15. The method of embodiment 14, further comprising:
modifying the digital rig plan to reduce the rig plan task score when the rig plan task score is higher than the desired rig plan risk score.

Embodiment 16. The method of embodiment 15, wherein modifying the digital rig plan comprises at least one of:
adding one or more new rig tasks to the digital rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

Embodiment 17. The method of embodiment 16, further comprising:
calculating a modified rig plan risk score based on the modified digital rig plan;
comparing the modified rig plan risk score to a desired rig plan risk score; and
further modifying the digital rig plan to reduce the rig plan task score when the modified rig plan task score is higher than the desired rig plan risk score.

Embodiment 18. The method of embodiment 1, wherein the individual proficiency score indicates a competency of the individual to perform a particular one of the rig tasks.

Embodiment 19. The method of embodiment 1, wherein two or more of the individual proficiency scores can be combined into a group proficiency score which indicates a competency of a group of individuals to perform a particular one of the rig tasks.

Embodiment 20. The method of embodiment 1, wherein the individual proficiency score for an individual performing a particular rig task of the available rig tasks is calculated based on at least one of:
a level of performance of the individual when the individual previously performed the particular rig task;
a level of compliance of the individual with required training for the particular rig task;
whether the individual is a short service employee (SSE);
an SSE level at which the individual is rated;
a level of experience the individual has with performing the particular rig task;
a level of experience the individual has with performing a similar task;
a level of experience the individual has working on the rig;
a level of experience the individual has working on a similar type of rig;
environmental conditions present when the individual previously performed the particular rig task;
hours worked before previously performing the particular rig task;
hours rested before previously performing the particular rig task;
vital signs of the individual before, during, and after previously performing the particular rig task; or
combinations thereof.

Embodiment 21. The method of embodiment 20, wherein the individual proficiency score comprises a historical proficiency component and a real-time proficiency component, wherein the historical proficiency component is stored in the database and retrieved when the rig controller is allocating one or more of the individuals to one or more of the rig tasks.

Embodiment 22. The method of embodiment 21, wherein the real-time proficiency component is updated in real-time based on data received at the rig controller from data sources positioned on or off the rig.

Embodiment 23. The method of embodiment 22, wherein the real-time proficiency component is updated during execution of the particular rig task based on at least one of:
a level of performance of the individual while performing the particular rig task;
an SSE level at which the individual is rated if the SSE level changes during performing the particular rig task;
a level of experience the individual is gaining while performing the particular rig task on the rig;
environmental conditions present while the individual is performing the particular rig task;
hours worked while performing the particular rig task;
hours rested while performing the particular rig task;
vital signs of the individual while performing the particular rig task; or combinations thereof.

Embodiment 24. The method of embodiment 1, further comprising:
the database comprising a plurality of rig equipment, the database comprising a rig equipment proficiency score for each of the rig equipment for each one of the available rig tasks on the rig, wherein each one of the available rig tasks requires at least one of the plurality of rig equipment; and
allocating one or more of the plurality of rig equipment to the rig tasks in the sequence of rig tasks based on respective rig equipment proficiency scores.

Embodiment 25. The method of embodiment 24, further comprising:
receiving a deviation from the digital rig plan;
determining a new sequence of rig tasks to perform the deviation from the digital rig plan, wherein the new sequence of rig tasks comprises a subset of the available rig tasks;
inserting the new sequence of rig tasks into the digital rig plan; and
allocating one or more of the individuals, one or more of the plurality of rig equipment, or combinations thereof to the rig tasks in the new sequence of rig tasks based on respective proficiency scores.

Embodiment 26. The method of embodiment 25, further comprising:
calculating, via the rig controller, a task risk score for each rig task in the digital rig plan based on the respective individual proficiency score for each of the one or more individuals allocated to each of the respective rig tasks in the digital rig plan and on the respective rig equipment proficiency score for each of the one or more rig equipment allocated to each of the respective rig tasks in the digital rig plan; and
calculating, via the rig controller, a rig plan risk score based on the task risk scores; and
storing the task risk scores and the rig plan risk score in the database.

Embodiment 27. The method of embodiment 26, further comprising:
comparing the rig plan risk score to a desired rig plan risk score.

Embodiment 28. The method of embodiment 27, further comprising:
modifying the digital rig plan to reduce the rig plan task score when the rig plan task score is higher than the desired rig plan risk score.

Embodiment 29. The method of embodiment 28, wherein modifying the digital rig plan comprises at least one of:
adding one or more new rig tasks to the rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

Embodiment 30. The method of embodiment 29, further comprising:
calculating a modified rig plan risk score based on the modified digital rig plan;
comparing the modified digital rig plan risk score to a desired rig plan risk score; and
further modifying the digital rig plan to reduce the rig plan task score when the modified rig plan task score is higher than the desired rig plan risk score.

Embodiment 31. The method of embodiment 24, wherein the rig equipment proficiency score indicates a competency of the rig equipment to perform a particular one of the rig tasks.

Embodiment 32. The method of embodiment 31, wherein the rig equipment proficiency score for the rig equipment performing a particular rig task of the available rig tasks is calculated based on at least one of:
a level of performance of the rig equipment when the rig equipment previously performed the particular rig task;
environmental conditions present when the rig equipment previously performed the particular rig task;
hours of operation;
hours of operation since last maintenance event;
health of the rig equipment;
emissions of the rig; or
combinations thereof.

Embodiment 33. The method of embodiment 32, wherein the rig equipment proficiency comprises a historical proficiency component and a real-time proficiency component, wherein the historical proficiency component is stored in the database and retrieved when the rig controller is allocating one or more of the rig equipment to one or more of the rig tasks.

Embodiment 34. The method of embodiment 33, wherein the real-time proficiency component is updated in real-time based on data received at the rig controller from data sources positioned on or off the rig.

Embodiment 35. The method of embodiment 34, wherein the real-time proficiency component is updated during execution of the particular rig task based on at least one of:
a level of performance of the rig equipment while performing the particular rig task;
environmental conditions present while the rig equipment is performing the particular rig task;
hours of operation while performing the particular rig task;
health of the rig equipment while performing the particular rig task; or
combinations thereof.

Embodiment 36. The method of embodiment 1, further comprising:
calculating for each particular rig task, via the rig controller, an individual risk score for each one of the one or more individuals allocated to a particular rig task of the sequence of rig tasks, wherein each of the individual risk scores is based on a respective individual proficiency score for the particular rig task;
calculating for each particular rig task, via the rig controller, an equipment risk score for rig equipment allocated to the particular rig task, wherein each of the equipment risk scores is based on a respective rig equipment proficiency score for the particular rig task; and
calculating, via the rig controller, a task risk score for each rig task in the sequence of rig tasks based on the respective individual risk scores and the respective equipment risk scores for the respective rig tasks.

Embodiment 37. The method of embodiment 36, further comprising:
calculating, via the rig controller, a rig plan risk score based on the task risk scores; and
storing the task risk scores and the rig plan risk score in the database.

Embodiment 38. The method of embodiment 36, wherein the calculating the task risk score for each rig task in the sequence of rig tasks is further based on environmental conditions in a work zone in which the particular rig task is to be performed.

Embodiment 39. The method of embodiment 38, wherein the environmental conditions are detected via data sources on or off the rig, and data from the data sources is transferred to the rig controller for calculating the task risk scores.

Embodiment 40. The method of embodiment 38, wherein the environmental conditions comprise at least one of:
snow;
rain;
sleet;
wind;
temperature;
pressure;
sea conditions for offshore rigs; or
combinations thereof.

Embodiment 41. A method for performing a subterranean operation, the method comprising:
receiving, at a rig controller, a digital rig plan which comprises a sequence of rig tasks to be performed on a rig, wherein the sequence of rig tasks comprises a subset of available rig tasks;
allocating one or more individuals to at least one of the rig tasks in the sequence of rig tasks based on a proficiency score for each individual for each of the rig tasks in the sequence of rig tasks;
conducting the digital rig plan via the rig;
receiving, at the rig controller, a deviation from the digital rig plan;
determining a new sequence of rig tasks to perform the deviation from the digital rig plan, wherein the new sequence of rig tasks comprises a subset of the available rig tasks;
inserting the new sequence of rig tasks into the digital rig plan; and
allocating one or more of the individuals to at least one of the rig tasks in the new sequence of rig tasks based on the proficiency score for each individual for each of the rig tasks in the new sequence of rig tasks.

Embodiment 42. The method of embodiment 41, further comprising:
calculating, via the rig controller, a task risk score for each rig task in the digital rig plan based on the respective individual proficiency score for each of the one or more individuals allocated to each of the respective rig tasks in the digital rig plan; and
calculating, via the rig controller, a rig plan risk score based on the task risk scores; and
storing the task risk scores and the rig plan risk score in a database.

Embodiment 43. The method of embodiment 42, further comprising:
comparing the rig plan risk score to a desired rig plan risk score.

Embodiment 44. The method of embodiment 43, further comprising:
modifying the digital rig plan to reduce the rig plan task score when the rig plan task score is higher than the desired rig plan risk score.

Embodiment 45. The method of embodiment 44, wherein modifying the digital rig plan comprises at least one of:
adding one or more new rig tasks to the digital rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

Embodiment 46. The method of embodiment 45, further comprising:
calculating a modified rig plan risk score based on the modified digital rig plan;
comparing the modified rig plan risk score to a desired rig plan risk score; and
further modifying the digital rig plan to reduce the rig plan task score when the modified rig plan task score is higher than the desired rig plan risk score.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for performing a subterranean operation, the method comprising:
generating, via a rig controller, a database of a plurality of individuals, the database comprising an individual proficiency score for each of the individuals for each one of available rig tasks on a rig, wherein each one of the available rig tasks requires at least one of the individuals;
receiving a digital rig plan which comprises a sequence of rig tasks to be performed on the rig, wherein the sequence of rig tasks comprises a subset of the available rig tasks; and
allocating one or more of the individuals to each of the rig tasks in the sequence of rig tasks based on respective individual proficiency scores.

2. The method of claim 1, further comprising:
calculating, via the rig controller, a task risk score for each rig task in the sequence of rig tasks based on the respective individual proficiency score for each of the one or more individuals allocated to each of the respective rig tasks; and
calculating, via the rig controller, a rig plan risk score based on the task risk scores; and
storing the task risk scores and the rig plan risk score in the database.

3. The method of claim 2, further comprising:
comparing the rig plan risk score to a desired rig plan risk score.

4. The method of claim 3, further comprising:
modifying the digital rig plan to reduce the rig plan risk score when the rig plan risk score is higher than the desired rig plan risk score.

5. The method of claim 4, wherein modifying the digital rig plan comprises at least one of:
adding one or more new rig tasks to the digital rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

6. The method of claim 5, further comprising:
calculating a modified rig plan risk score based on the modified digital rig plan;
comparing the modified rig plan risk score to a desired rig plan risk score; and
further modifying the digital rig plan to reduce the rig plan task score when the modified rig plan task score is higher than the desired rig plan risk score.

7. The method of claim 1, further comprising:
calculating, via the rig controller, an individual risk score for each one of the one or more individuals allocated to a particular rig task of the sequence of rig tasks.

8. The method of claim 7, wherein the individual risk score indicates a probability that the respective one of the one or more individuals will satisfactorily complete the particular rig task.

9. The method of claim 7, wherein the individual risk score for an individual performing a particular rig task of the available rig tasks is calculated based on at least one of:
the respective individual proficiency score;
current health of the individual;
current fatigue of the individual;
projected fatigue of the individual; and
environmental conditions in a work zone of the particular rig task; or
combinations thereof.

10. The method of claim 9, wherein the individual risk score comprises a historical risk component and a real-time risk component, wherein the historical risk component is stored in the database and retrieved when the rig controller is allocating one or more of the individuals to one or more of the rig tasks.

11. The method of claim 10, wherein the real-time risk component is updated in real-time based on data received at the rig controller from data sources positioned on or off the rig.

12. The method of claim 1, further comprising:
receiving a deviation from the digital rig plan;
determining a new sequence of rig tasks to perform the deviation from the digital rig plan, wherein the new sequence of rig tasks comprises a subset of the available rig tasks;
inserting the new sequence of rig tasks into the digital rig plan; and
allocating one or more of the individuals to the rig tasks in the new sequence of rig tasks based on the respective individual proficiency scores.

13. The method of claim 12, further comprising:
calculating, via the rig controller, a task risk score for each rig task in the digital rig plan based on the respective individual proficiency score for each of the one or more individuals allocated to each of the respective rig tasks in the digital rig plan; and
calculating, via the rig controller, a rig plan risk score based on the task risk scores; and
storing the task risk scores and the rig plan risk score in the database.

14. The method of claim 13, further comprising:
comparing the rig plan risk score to a desired rig plan risk score.

15. The method of claim 14, further comprising:
modifying the digital rig plan to reduce the rig plan task score when the rig plan task score is higher than the desired rig plan risk score.

16. The method of claim 15, wherein modifying the digital rig plan comprises at least one of:
adding one or more new rig tasks to the digital rig plan;
modifying one or more of the rig tasks in the sequence of rig tasks;
modifying an allocation of the one or more individuals for one or more of the rig tasks in the sequence of rig tasks; and
modifying an allocation of rig equipment for one or more rig tasks in the sequence of rig tasks.

17. The method of claim 16, further comprising:
calculating a modified rig plan risk score based on the modified digital rig plan;
comparing the modified rig plan risk score to a desired rig plan risk score; and
further modifying the digital rig plan to reduce the rig plan task score when the modified rig plan task score is higher than the desired rig plan risk score.

18. The method of claim 1, wherein the individual proficiency score indicates a competency of the individual to perform a particular one of the rig tasks.

19. The method of claim 1, wherein two or more of the individual proficiency scores can be combined into a group proficiency score which indicates a competency of a group of individuals to perform a particular one of the rig tasks.

20. The method of claim 1, wherein the individual proficiency score for an individual performing a particular rig task of the available rig tasks is calculated based on at least one of:
a level of performance of the individual when the individual previously performed the particular rig task;
a level of compliance of the individual with required training for the particular rig task;
whether the individual is a short service employee (SSE);
an SSE level at which the individual is rated;
a level of experience the individual has with performing the particular rig task;
a level of experience the individual has with performing a similar task;
a level of experience the individual has working on the rig;
a level of experience the individual has working on a similar type of rig;
environmental conditions present when the individual previously performed the particular rig task;
hours worked before previously performing the particular rig task;
hours rested before previously performing the particular rig task;
vital signs of the individual before, during, and after previously performing the particular rig task; or
combinations thereof.
